(19) United States
(12) Patent Application Publication
(10) Pub. No.: US 2009/0089848 A1
(43) Pub. Date: Apr. 2, 2009

(54) MOVING PICTURE DISTRIBUTION SYSTEM, SUBSCRIBER LINE TERMINATION DEVICE, MOVING PICTURE DISTRIBUTION METHOD, MOVING PICTURE DISTRIBUTION PROGRAM, AND RECORDING MEDIUM

(76) Inventor: SOU SATOU, Tokyo (JP)

Correspondence Address: NEC CORPORATION OF AMERICA, 6535 N. STATE HWY 161, IRVING, TX, 75039, US

(21) Appl. No.: 12/236,146

(22) Filed: Sep. 23, 2008

(30) Foreign Application Priority Data
Sep. 28, 2007 (JP) 2007-255678

(51) Int. Cl. H04N 7/173

(52) U.S. Cl. 725/109

(57) ABSTRACT

The present invention provides a moving picture distribution system, a subscriber line termination device, a moving picture distribution method, a moving picture distribution program, and a recording medium, that may sufficiently distribute moving picture data according to a link speed by an IP multicast manner. The moving picture distribution system includes a subscriber line termination device connected to a moving picture distribution network to perform a terminating process of a subscriber line; and an image reproduction device connected to the subscriber line termination device through a domestic termination device, wherein the subscriber line termination device selects a server according to a link speed with the domestic termination device and transmits moving picture data of a same content to the domestic termination device at the link speed by a multicast manner.

This application is based upon and claims the benefit of priority from Japanese patent application No. 2007-255678, filed on Sep. 28, 2007, the disclosure of which is incorporated herein in its entirety by reference.

### BACKGROUND OF THE INVENTION

1. Field of the Invention

The present invention relates to a moving picture distribution system, a subscriber line termination device, a moving picture distribution method, a moving picture distribution program, and a recording medium.

2. Description of Related Art

In recent years, improvement of Internet technologies has allowed for increase of subscribers that desire distribution of moving pictures. Accordingly, moving picture distribution systems have been sharply developed.

A moving picture distribution system using a subscriber line termination device that mounts interfaces having the different link speeds will be described as an example of these kinds of moving picture distribution systems.

FIG. 8 depicts a construction of a moving picture distribution system using a subscriber line termination device according to the present invention.

Referring to FIG. 8, the subscriber line termination device 601 includes both a low speed line interface 602 and a high speed interface 603, and distributes moving picture data from a moving picture distribution network 604 to each image reproduction device 606 under the control of each domestic termination device 605 by an IP (Internet Protocol) multicast manner regardless of the link speed of each line.

Inventions related to the moving picture distribution system are disclosed in the patent documents 1 to 3.

The patent document 1 (Japanese Patent Application Laid-Open (JP-A) No. 2002-183014) discloses content distribution system and method distributing content requested by a plurality of clients from a center server to the plurality of clients over a network, wherein a plurality of edge servers are arranged at the side of the clients over the network. And, the center server described in the patent document 1 includes a storing means for storing contents. The center server receives a content request from the clients and reserves the type and destination of the requested content.

The invention described in the patent document 1 includes a reserving means that reserves a plurality of clients as the destination of the content when the same content is requested from the plurality of clients, and a means that reads out a reserved content from the storing mean and transmits the read content to the plurality of destination clients by a multicast manner.

The edge server includes a means that transmits content request from the client to the center server, and a means that receives content from the center server and converts the received content to have such a communication speed that the destination client may receive the content, and transmits the converted content to the destination client. The network secures a constant resource between the center server and the whole edge servers and transmits content from the center server to the edge servers by a multicast manner.

The invention described in the patent document 1 operates as below.

A plurality of edge servers 102 to 104 are arranged at the side of clients over the network. The edge servers transmit content request from the clients to the center server so that the center server reserves the type and destination of the requested content. In a case where the same content is requested from the plurality of clients, the center server reserve the plurality of clients as the destination of the content, and reads out a reserved content from the storing means to transmit the read content to the plurality of destination clients by a multicast manner. The edge servers receive the transmitted content, convert the received content to have such a communication speed that the destination clients may receive the content, and transmit the converted content to the destination clients.

The patent document 2 (JP-A No. 2004-260289) discloses a traffic aggregation system and method, a program, and a recording medium, wherein the traffic aggregation system that manages traffic transmission and multicast traffic aggregation is connected to a plurality of user terminals that request and receive traffics through a network. The user terminal includes a reproduction state management means that performs a reproduction state management and a reproduction state notification, and a receipt state management means that performs a receipt state management and a receipt state notification.

The aggregation system includes a database that stores network information, user information, and traffic transmission information, a traffic transmission means that performs a traffic transmission control, a transmission management means that performs a transmission management, and management and update of the database, a determination means that performs a multicast aggregation determination based on each information stored in the database, and a timer means that manages a timing of an information collection request and a timing of a determination request. The aggregation system revokes some of traffics which have a large amount of transmission and adjusts the amount of transmission of each traffic to aggregate a plurality of multicast traffics of the same type.

The invention described in the patent document 2 operates as below.

The invention described in the patent document 2 may implement a traffic aggregation system that may determine the optimal multicast aggregation trigger depending on dynamic variations all over the network such as the amount of received multicast traffics and reproduction/non-reproduction information, and aggregate transmissions of multicast traffics.

The patent document 3 (JP-A No. 2006-222659) discloses a radio communication device, and a radio communication system and method, wherein the radio communication device wirelessly distributes received multicast packets to a plurality of radio terminals. The radio communication device includes a communication speed determination means and a radio communication means. The communication speed determination means determines the slowest communication speed out of communication speeds by which a plurality of radio terminals, which will or have participated in any multicast group, may receive packets as a communication speed of the multicast packets in the multicast group. The radio communication means wirelessly transmits received multicast packets in the multicast group at the communication speed determined by the communication speed determination means.

The invention described in the patent document 3 operates as below.

The invention described in the patent document 3 may aggregate the plurality of multicast traffics having different transmission states, thus reducing the bandwidth used for the network, the amount of traffics, the number of IP addresses used, and the number of multicast tables managed by nodes. Additionally, the invention described in the patent document 3 may gather various types of information to determine whether or not to perform an appropriate multicast traffic aggregation conversion, thus making it possible to determine the aggregation trigger and convert a plurality of multicast traffic transmissions into an aggregated multicast traffic transmission.

However, the construction shown in FIG. 8 has a problem of not being able to distribute high quality moving picture data appropriate for the high speed line interface 603 through the low speed line interface 602 by an IP multicast manner due to lack of transmission bandwidth. Moreover, the above construction may distribute low quality moving picture data appropriate for the low speed line interface 602 through the high speed line interface 603, but may not perform high quality IP multicast distribution despite some margin in the transmission bandwidth.

When the image reproduction devices 606 select the optimal moving picture data by an IP multicast function, many image reproduction devices 606 located over the network need to perform a multicast control according to the link speed or be remotely controlled by a moving picture distribution server or network management server included in the moving picture distribution network 604, and this may cause the establishment and management of the network to be complicated.

Furthermore, the inventions disclosed in the patent documents 1 to 3 have a problem of not being able to sufficiently distribute moving picture data according to a link speed by an IP multicast manner.

### SUMMARY

The present invention has been made in terms of the above problems, and an object of the present invention is to provide a moving picture distribution system, a subscriber line termination device, a moving picture distribution method, a moving picture distribution program, and a recording medium that may sufficiently distribute moving picture data according to a link speed by an IP multicast manner.

The present invention has the below features to accomplish the above object.

<Moving Picture Distribution System>

The moving picture distribution system according to the present invention includes a subscriber line termination device connected to a moving picture distribution network to perform a terminating process of a subscriber line; and an image reproduction device connected to the subscriber line termination device through a domestic termination device, wherein the subscriber line termination device selects a server according to a link speed with the domestic termination device and transmits moving picture data of a same content to the domestic termination device at the link speed by a multicast manner.

The subscriber line termination device according to the present invention distributes moving picture data from a moving picture distribution network to an image reproduction device connected to a domestic termination device, wherein the subscriber line termination device selects a server according to a link speed with a domestic termination device and transmits moving picture data of a same content to the domestic termination device at the link speed by a multicast manner.

<Moving Picture Distribution Method>

A moving picture distribution method according to the present invention distributes moving picture data from a moving picture distribution network to an image reproduction device connected to a domestic termination device, wherein the subscriber line termination device selects a server according to a link speed with the domestic termination device and transmits moving picture data of a same content from the moving picture distribution network to the domestic termination device at the link speed by a multicast manner.

<Program>

Further, a moving picture distribution program according to the present invention enables a multicast control unit to perform a process of distributing moving picture data from a moving picture distribution network to an image reproduction device connected to a domestic termination device, wherein the moving picture distribution program enables the multicast control unit to select a server according to a link speed with the domestic termination device and transmit moving picture data of a same content from the moving picture distribution network to the domestic termination device at the link speed by a multicast manner.

<Recording Medium Storing Program>

A recording medium according to the present invention stores the moving picture distribution program.

### BRIEF DESCRIPTION OF THE DRAWINGS

FIG. 1 is a block diagram illustrating a moving picture distribution system according to an exemplary embodiment of the present invention.

FIG. 2 is a block diagram illustrating the subscriber line termination device included in the link speed linked moving picture distribution system shown in FIG. 1.

FIG. 3 is a block diagram illustrating the subscriber line termination device and the domestic termination device included in the link speed linked moving picture distribution system shown in FIG. 1.

FIG. 4 is a flowchart illustrating a moving picture distribution method according to an exemplary embodiment of the present invention.

FIG. 5 is a flowchart illustrating a moving picture distribution method according to another exemplary embodiment of the present invention.

FIG. 6 is a flowchart illustrating a moving picture distribution method according to still another exemplary embodiment of the present invention.

FIG. 7 is a flowchart illustrating a moving picture distribution method according to yet still another exemplary embodiment of the present invention.

FIG. 8 is a block diagram illustrating a construction of a moving picture distribution system using a subscriber line termination device according to the present invention.

### EXEMPLARY EMBODIMENT

The subscriber line termination device according to the present invention, which may mount interfaces having different link speeds, interfaces whose link speed changes dynamically, or interfaces, which may interface to domestic termination devices having different link bandwidths, may perform IP multicast distribution of the optimal moving picture data according to the state of each interface.

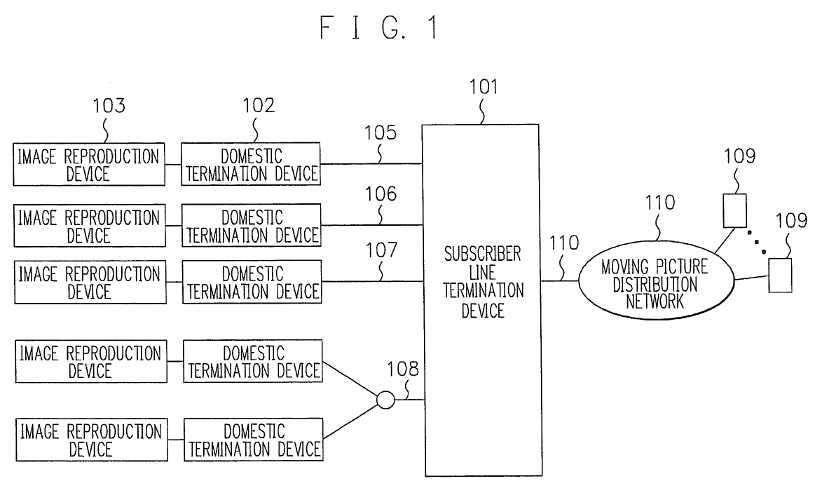

FIG. 1 is a block diagram illustrating a moving picture distribution system according to an exemplary embodiment of the present invention.

The moving picture distribution system shown in FIG. 1 is an example of a link speed linked moving picture distribution system, and includes a moving picture distribution network 104, a subscriber line termination device 101, a domestic termination device 102, and an image reproduction device 103.

The moving picture distribution network 104, which includes a plurality of servers 109, is connected to the subscriber line termination device 101 via a line 110.

A plurality of lines 105 to 108 (although four lines have been illustrated in FIG. 1, the present invention is not limited thereto) are connected to the subscriber line termination device 101.

The line 105 refers to a low speed line such as ADSL (Asymmetric Digital Subscriber Line), the line 106 refers to a high speed line such as gigabit Ethernet (registered trademark), the line 107 refers to a line having a dynamic link speed adjustment function RA (Rate Adaptation) used for DSL (Digital Subscriber Line), and the line 108 refers to an N:1 connection line, such as PON, which may interface to the domestic termination devices 102 having different link speeds.

The subscriber line termination device 101 may terminate the various lines 105 to 108 for subscriber interface, select the server 109 according to a link speed with the domestic termination device 102, and transmit movie image data of the same content to each domestic termination device 102 at the link speed by a multicast manner.

The subscriber line termination device 101 transmits and receives a multicast message, such as IGMP (Internet Group Management Protocol) or MLD (Multicast Listener Discovery), via IGMP/MLD snooping or proxy between the image reproduction device 103 and the moving picture distribution network 104. Accordingly the subscriber line termination device 101 may receive the optimal moving picture data from the moving picture distribution network 104 by an IP multicast manner based on information on the various lines 105 to 108, and then transmit the received optimal moving picture data to the various lines 105 to 108.

Each domestic termination device 102 is connected to each image reproduction device 103. The image reproduction device 103 has a multicast protocol function such as IGMP or MLD to perform a request from a participating or seceding multicast group to output received moving picture data as an image.

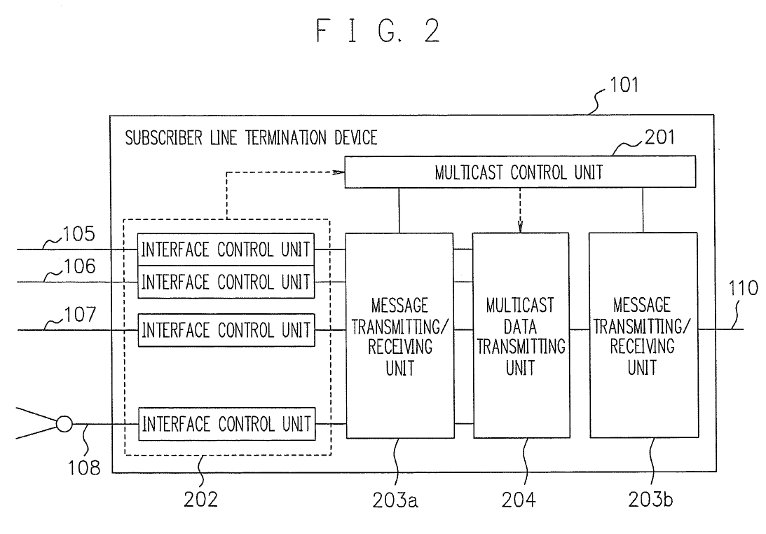

FIG. 2 is a block diagram illustrating the subscriber line termination device included in the link speed linked moving picture distribution system shown in FIG. 1.

The subscriber line termination device 101 includes an interface control unit 202, message transmitting/receiving units 203a and 203b, a multicast control unit 201, and a multicast data transmitting unit 204.

The interface control unit 202 terminates various subscriber interfaces that are connected to the domestic termination device 102 (refer to FIG. 1).

The message transmitting/receiving units 203a and 203b provide a structure that may transmit/receive only the multicast message, such as IGMP or MLD, between the interface control unit 202 and the multicast control unit 201.

The multicast control unit 201 performs transmission/receipt of a multicast message based on information from the interface control unit 202.

The multicast data transmitting unit 204 distributes the moving picture data received from a line 209 for interface, which is connected to the moving picture distribution network, to the various lines 105 to 108 for interface in response to an instruction from the multicast control unit 201.

Firstly, the interface control unit 202 will be described.

The interface control unit 202 notifies the multicast control unit 201 of a current link speed upon establishment of a connection with the domestic termination device 102 (refer to FIG. 1). For example, in a case where the interface control unit 202 is connected to the domestic termination device 102 via the low speed line 105 such as ADSL or the high speed line 106 such as gigabit Ethernet that does not have a dynamic link speed adjustment function, the interface control unit 202 notifies the multicast control unit 201 of the current link speed only upon establishment of a connection with the domestic termination device 102. In a case where the interface control unit 202 is connected to the domestic termination device 102 via the line 107 such as DSL that has a dynamic link speed adjustment function, the interface control unit 202 notifies the multicast control unit 201 of the current link speed according to dynamic variation in speed. In a case where the interface control unit 202 is connected to the domestic termination device 102 via the N:1 connection line 108 such as PON that may interface to the domestic termination devices having different link speeds, the interface control unit 202 notifies the multicast control unit 201 of the link speed for each and every domestic termination device 102 (refer to FIG. 1) under connection.

Next, the message transmitting/receiving unit 203a will be described.

The message transmitting/receiving unit 203a transmits a multicast message received from line 105 to 109 for each interface to the multicast control unit 201. Upon the transmission of the multicast message, the message transmitting/receiving unit 203a also transmits received information on a physical interface or logical interface to the multicast control unit 201. A message transmitted from the multicast control unit 201 is transmitted to each line 105 to 108 and 110 for interface via the message transmitting/receiving units 203a and 203b. The multicast control unit 201 may designate an interface for transmission as well as a message for transmission. The message transmitting/receiving units 203a and 203b transmit a message according to the designated interface.

Next, the multicast control unit 201 will be described.

The multicast control unit 201 has a multicast function such as IGMP/MLD snooping or proxy, and performs transmission/receipt of a multicast message via the message transmitting/receiving units 203a and 203b. The determination of a multicast group for receipt by the message is controlled based on information notified from the interface control unit 202. The multicast control 201 sets multicast data and interface for transmission of the multicast data transmission unit 204 at the time point when a multicast group for receipt has been determined.

Finally, the multicast data transmission unit 204 will be described.

The multicast data transmitting unit 204 transmits data for an approved multicast group to the designated interface in response to an instruction from the multicast control unit 201.

### Description of Operation

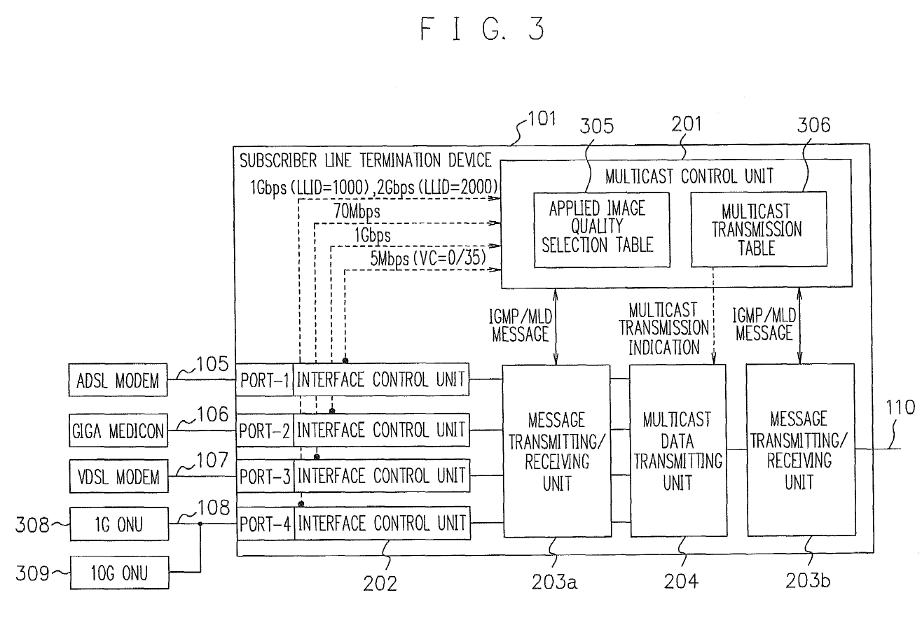

An operation of the subscriber line termination device will be described with reference to FIG. 3.

FIG. 3 is a block diagram illustrating the subscriber line termination device and the domestic termination device included in the link speed linked moving picture distribution system shown in FIG. 1.

In the subscriber line termination device 101 shown in FIG. 3, a Port-1 interface control unit 202 is connected to the line 105 for ADSL interface, wherein ATM VC number is set as 0/35 and the link speed is set as 5 Mbps. Similarly, a Port-2 interface control unit 202 is connected to the line 106 for gigabit interface, and a Port-3 interface control unit 202 whose link speed is 1 Gbps is connected to the line 107 for VDSL interface. A Port-4 interface control unit 202 whose link speed is 70 Mbps is connected to the line 108 for GE-PON interface, wherein 1 G ONU (308) that has an LLID number of 1000 and a link speed of 1 Gbps and 10 G ONU (309) that has an LLID number of 2000 and a link speed of 10 Gbps, respectively, are set for multicast data transmission. The information on the link speed of each interface is notified to the multicast control unit 201.

The multicast control unit 201 stores an applied image quality selection table 305 to determine line speed and applied image quality. Tables 1 and 2 represent the applied image quality selection table 305.

TABLE 1

| | | Transmitting source |
|---|---|---|
| Line speed | Applied image quality | address |
| Less than 10 Mbps | Lowest image quality | Sender-1 |
| 10 Mbps to | Low image quality | Sender-2 |
| less than 50 Mbps | | |
| 50 Mbps to | Middle image quality | Sender-3 |
| less than 1 Gbps | | |
| 1 Gbps to | High image quality | Sender-4 |
| less than 2 Gbps | | |
| 2 Gbps or more | Highest image quality | Sender-5 |

TABLE 2

| | | Upper level multicast |
|---|---|---|
| Line speed | Applied image quality | group |
| Less than 10 Mbps | Lowest image quality | 224.1.0.0/24 |
| 10 Mbps to | Low image quality | 224.2.0.0/24 |
| less than 50 Mbps | | |
| 50 Mbps to | Middle image quality | 224.3.0.0/24 |
| less than 1 Gbps | | |
| 1 Gbps to | High image quality | 224.4.0.0/24 |
| less than 2 Gbps | | |
| 2 Gbps or more | Highest image quality | 224.5.0.0/24 |

The applied image quality selection table 305 determines the quality of an image to be transmitted to a subscriber according to the line speed. Table 1 represents an example of a table obtainable in a case where it is assumed that the image quality of moving picture data is different for each transmitting source address of a multicast distribution server. Table 2 represents an example obtainable in a case where it is assumed that the image quality of moving picture data is different for each multicast group address.

In Table 1, even though the lines 105 to 108 for subscriber interface have participated in the same multicast group address “224.1.0.1”, the multicast control unit 201 establishes a multicast transmission table 306 having different transmitting source addresses according to the line speed of the interface and notifies the line 110 for interface, which is connected to an upper level network, of a multicast message requesting participation or secession.

Table 3 represents the multicast transmission table 306.

TABLE 3

| Transmitting | | | |
|---|---|---|---|
| source address | Multicast group | Interface | |
| Sender-1 | 224.1.0.1 | Port-1 | VC = 0/35 |
| Sender-3 | 224.1.0.1 | Port-3 | |
| Sender-4 | 224.1.0.1 | Port-2 | |
| | | Port-4 | LLID = 1000 |
| Sender-5 | 224.1.0.1 | Port-4 | LLID = 2000 |

The multicast control unit 201 performs a setup in the multicast data transmitting unit 204 according to the multicast transmission table 306. The multicast data transmitting unit 204 transmits multicast data according to a transmitting source address, a multicast group, and interface information.

In Table 2, even though the lines 105 to 108 for subscriber interface have participated in the same multicast group address “224.1.0.1”, the multicast control unit 201 establishes a multicast transmission table 306 having different multicast addresses in an upper level network according to the line speed of each interface and notifies the line 110 for interface, which is connected to the upper level network, of a multicast message requesting participation or secession. Table 4 represents the multicast transmission table 306.

TABLE 4

| Subscriber | Upper level | | |
|---|---|---|---|
| multicast group | multicast group | | Interface |
| 224.1.0.1 | 224.1.0.1 | Port-1 | VPI/VCI = 0/35 |
| 224.1.0.1 | 224.3.0.1 | Port-3 | |
| 224.1.0.1 | 224.4.0.1 | Port-2 | |
| | | Port-4 | LLID = 1000 |
| 224.1.0.1 | 224.5.0.1 | Port-4 | LLID = 2000 |

The multicast control unit 201 performs a setup in the multicast data transmitting unit 204 according to the multicast transmission table 306. The multicast data transmitting unit 204 performs an address change from the upper level multicast address to the subscriber multicast address for the multicast data, and then transmits multicast data according to the designated interface information.

Accordingly, the subscriber line termination device 101 may distribute moving picture data having image quality appropriate for the link speed of each line 105 to 108 for subscriber interface.

### Description of Effect

The exemplary embodiment of the present invention has a first effect that the subscriber line termination device, which may mount a plurality of interfaces having different link speeds, may distribute moving picture data according to the link speed by an IP multicast manner.

The exemplary embodiment of the present invention has a second effect that the subscriber line termination device, which may mount an interface having varying link speed while maintaining a link-up state, may distribute moving picture data according to varying link speed by an IP multicast manner.

The exemplary embodiment of the present invention has a third effect that the subscriber line termination device, which may connect a plurality of domestic termination devices having different link speeds to a single interface, may distribute moving picture data according to the link speed of each domestic termination device by an IP multicast manner.

The exemplary embodiment of the present invention has a fourth effect that the domestic termination device and the moving picture reproduction device may receive the optimal moving picture data by an IP multicast manner without any need of considering the link speed of the subscriber line because the subscriber termination device may distribute moving picture data according to the link speed of each interface.

The exemplary embodiment of the present invention has a fifth effect that the moving picture distribution server and the network management server included in the moving picture distribution network do not have any necessity of managing the link speed or link state in the subscriber line because the subscriber termination device may distribute moving picture data according to the link speed of each interface.

### Another Exemplary Embodiment

It should be noted that the above mentioned exemplary embodiment is merely a preferred exemplary embodiment of the present invention, and the present invention is not limited thereto. Accordingly, various modifications may be made without departing from the spirit of the present invention. For example, any interface, which may detect the link speed in the subscriber line termination device, may distribute moving picture data by an IP multicast manner according to the bandwidth of the interface regardless of the type and connection form of the interface.

In addition, the data distributed by the IP multicast manner is not limited to the moving picture data, and the present invention may be applicable to any data, such as voice data, which may be distributed by the IP multicast manner.

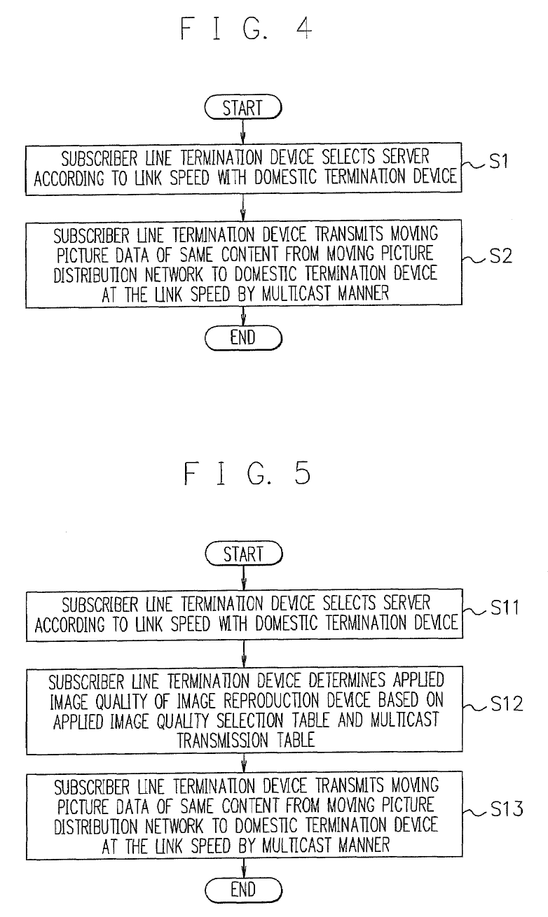

FIG. 4 is a flowchart illustrating a moving picture distribution method according to an exemplary embodiment of the present invention.

The moving picture distribution method shown in FIG. 4 distributes moving picture data from the moving picture distribution network 104 (refer to FIG. 1) to the image reproduction device connected to each domestic termination device. The subscriber line termination device 101 (refer to FIG. 1) selects a server 109 according to a link speed with the domestic termination device 102 (step S1).

The subscriber line termination device 101 transmits moving picture data of the same content from the moving picture distribution network 104 to each domestic termination device 102 at the link speed by a multicast manner (step S2).

This sufficiently enables the distribution of the moving picture data according to the link speed by the IP multicast manner.

FIG. 5 is a flowchart illustrating a moving picture distribution method according to another exemplary embodiment of the present invention.

The moving picture distribution method shown in FIG. 5 distributes moving picture data from the moving picture distribution network 104 (refer to FIG. 1) to the image reproduction device connected to each domestic termination device. The subscriber line termination device 101 (refer to FIG. 1) selects a server 109 according to the link speed with the domestic termination device 102 (step S11).

If the interface control unit 202 (refer to FIG. 2) connected to the domestic termination device 102 (refer to FIG. 3) notifies the subscriber line termination device 101 of the link speed, the subscriber line termination device 101 determines the applied image quality of the image reproduction device 103 based on the applied image quality selection table 305 and the multicast transmission table 306 (refer to FIG. 3) (step S12).

The subscriber line termination device 101 transmits moving picture data from the moving picture distribution network 104 to each domestic termination device 102 by a multicast manner (step S13).

This sufficiently enables the distribution of the moving picture data according to the link speed by the IP multicast manner.

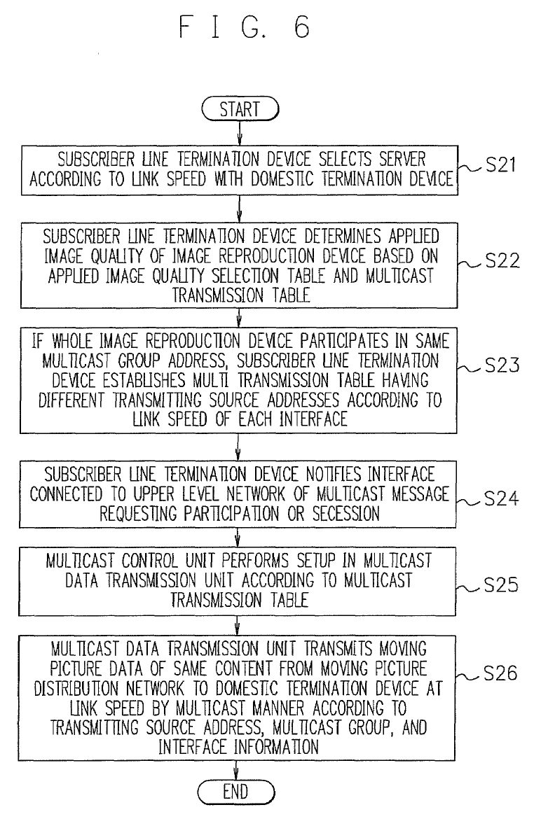

FIG. 6 is a flowchart illustrating a moving picture distribution method according to still another exemplary embodiment of the present invention.

The moving picture distribution method shown in FIG. 6 distributes moving picture data from the moving picture distribution network 104 (refer to FIG. 1) to the image reproduction device connected to each domestic termination device. The subscriber line termination device 101 (refer to FIG. 1) selects a server 109 according to a link speed with the domestic termination device 102 (step S21).

If the interface control unit 202 (refer to FIG. 2) connected to the domestic termination device 102 (refer to FIG. 3) notifies the subscriber line termination device 101 of the link speed, the subscriber line termination device 101 determines the applied image quality of the image reproduction device 103 based on the applied image quality selection table 305 and the multicast transmission table 306 (refer to FIG. 3) (step S22).

In a case where the whole image reproduction devices 103 participate in the same multicast group address, the subscriber line termination device 101 establishes a multicast transmission table having different transmitting source addresses according to the link speed of each interface (step S23).

The subscriber line termination device 101 notifies the interface connected to an upper level network of a multicast message requesting participation or secession.

The multicast control unit 201 performs a setup in the multicast data transmitting unit 204 according to the multicast transmission table (step S25).

The multicast data transmitting unit 204 transmits the moving picture data from the moving picture distribution network 104 to each domestic termination device 102 by a multicast manner (step S26).

This sufficiently enables the distribution of the moving picture data according to the link speed by the IP multicast manner.

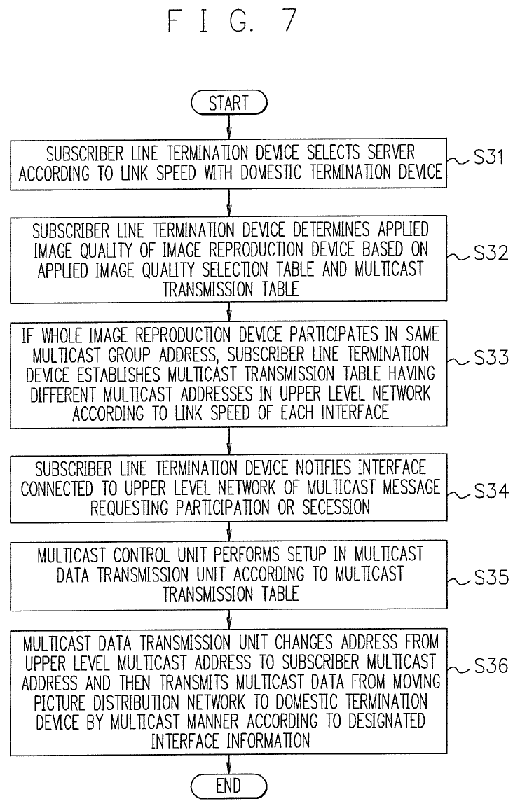

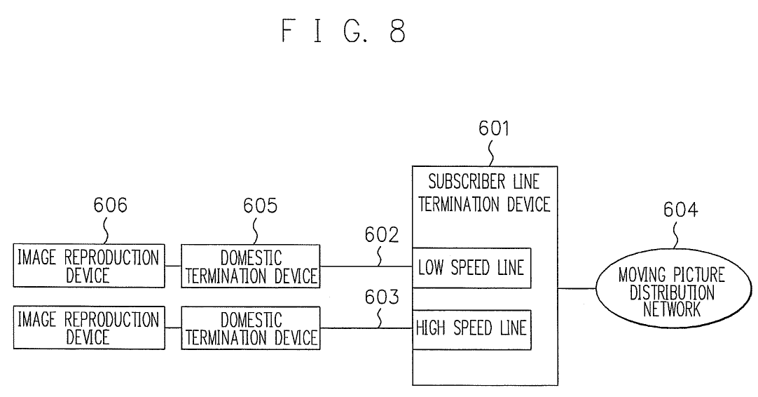

FIG. 7 is a flowchart illustrating a moving picture distribution method according to yet still another exemplary embodiment of the present invention.

The moving picture distribution method shown in FIG. 7 distributes moving picture data from the moving picture distribution network 104 (refer to FIG. 1) to the image reproduction device connected to each domestic termination device. The subscriber line termination device 101 (refer to FIG. 1) selects a server 109 according to the link speed with the domestic termination device 102 (step S31).

If the interface control unit 202 connected to the domestic termination device 102 (refer to FIG. 3) notifies the subscriber line termination device 101 of the link speed, the subscriber line termination device 101 determines the applied image quality of the image reproduction device 103 based on the applied image quality selection table 305 and the multicast transmission table 306 (refer to FIG. 3).

In a case where the whole image reproduction devices 103 participate in the same multicast group address, the subscriber line termination device 101 establishes a multicast transmission table having different multicast addresses in an upper level network according to the link speed of each interface (step S33).

The subscriber line termination device 101 notifies the interface connected to the upper level network of a multicast message requesting participation or secession (step S34).

The multicast control unit 201 (refer to FIG. 1) performs a setup in the multicast data transmitting unit 204 according to the multicast transmission table 306 (step S35).

The multicast data transmitting unit 204 changes the address of the multicast data from an upper level multicast address to a subscriber multicast address, and transmits the moving picture data from the moving picture distribution network to each domestic termination device according to designated interface information by a multicast manner (step S36).

This sufficiently enables the distribution of the moving picture data according to the link speed by the IP multicast manner.

<Program and Recording Medium>

The moving picture distribution system of the present invention described above may be implemented as a moving picture distribution program that executes a moving picture distribution process in a computer.

The moving picture distribution program corresponds to the flowcharts shown in FIGS. 4 to 7. The computer may include, but not limited to, a general purpose computer such as a personal computer or workstation.

Accordingly, any computing environment, which may execute the moving picture distribution program, may implement the moving picture distribution system of the present invention.

This program may be recorded in a computer readable recording medium.

The recording medium may include, for example, a computer readable recording medium such as CD-ROM (Compact Disc Read Only Memory), Flexible Disk (FD), CD-R (CD Recordable), DVD (Digital Versatile Disk), etc., a semiconductor memory such as RAM (Random Access Memory), ROM (Read Only Memory), FeRAM, etc., and HDD (Hard Disc Drive).

### EXAMPLE

### First Exemplary Embodiment

According to the first exemplary embodiment of the present invention, the moving picture distribution system includes a subscriber line termination device connected to a moving picture distribution network to perform a terminating process of a subscriber line; and an image reproduction device connected to the subscriber line termination device through a domestic termination device, wherein the subscriber line termination device selects a server according to a link speed with the domestic termination device and transmits moving picture data of a same content to the domestic termination device at the link speed by a multicast manner.

### Second Exemplary Embodiment

According to the second exemplary embodiment of the present invention, further to the construction described in the first exemplary embodiment, the subscriber line termination device includes a first message transmitting/receiving unit connected to the moving picture distribution network to transmit/receive a serial-type message, a multicast data transmitting unit connected to the first message transmitting/receiving unit to transmit multicast data, a second message transmitting/receiving unit connected to the multicast data transmitting unit to transmit/receive a parallel-type message, an interface control unit connected to the second message transmitting/receiving unit to connect to the domestic termination device, and a multicast control unit that controls the first and second message transmitting/receiving units and the multicast data transmitting unit.

### Third Exemplary Embodiment

According to the third exemplary embodiment of the present invention, further to the construction described in the second exemplary embodiment, the multicast control unit includes an applied image quality selection table that stores data for determining a line speed and an image reproduction device, and a multicast transmission table that stores data for determining a link speed of an interface and a multicast address.

### Fourth Exemplary Embodiment

According to the fourth exemplary embodiment of the present invention, a subscriber line termination device for distributing moving picture data from a moving picture distribution network to an image reproduction device connected to a domestic termination device, wherein the subscriber line termination device selects a server according to a link speed with a domestic termination device and transmits moving picture data of a same content to the domestic termination device at the link speed by a multicast manner.

### Fifth Exemplary Embodiment

According to the fifth exemplary embodiment of the present invention, further to the construction described in the fourth exemplary embodiment, the subscriber line termination device includes a first message transmitting/receiving unit connected to the moving picture distribution network to transmit/receive a serial-type message, a multicast data transmitting unit connected to the first message transmitting/receiving unit to transmit multicast data, a second message transmitting/receiving unit connected to the multicast data transmitting unit to transmit/receive a parallel-type message, an interface control unit connected to the second message transmitting/receiving unit to connect to the domestic termination device, and a multicast control unit that controls the first and second message transmitting/receiving units and the multicast data transmitting unit.

### Sixth Exemplary Embodiment

According to the sixth exemplary embodiment of the present invention, further to the construction described in the fifth exemplary embodiment, the multicast control unit includes an applied image quality selection table that stores data for determining a line speed and an image reproduction device, and a multicast transmission table that stores data for determining a link speed of an interface and a multicast address.

### Seventh Exemplary Embodiment

According to the seventh exemplary embodiment of the present invention, a moving picture distribution method for distributing moving picture data from a moving picture distribution network to an image reproduction device connected to a domestic termination device, wherein the subscriber line termination device selects a server according to a link speed with the domestic termination device and transmits moving picture data of a same content from the moving picture distribution network to the domestic termination device at the link speed by a multicast manner.

### Eighth Exemplary Embodiment

According to the eighth exemplary embodiment of the present invention, further to the construction described in the seventh exemplary embodiment, if an interface control unit connected to the domestic termination device notifies the subscriber line termination device of a link speed, the subscriber line termination device determines an applied image quality of the image reproduction device based on an applied image quality selection table that stores data for determining a line speed and an image reproduction device and a multicast transmission table that stores data for determining a link speed of an interface and a multicast address, and transmits the moving picture data from the moving picture distribution network to the domestic termination device by a multicast manner.

### Ninth Exemplary Embodiment

According to the ninth exemplary embodiment of the present invention, further to the construction described in the eighth exemplary embodiment, if the whole image reproduction device participates in a same multicast group address, the subscriber line termination device establishes a multicast transmission table having different transmitting source addresses according to a link speed of each interface and notifies an interface connected to an upper level network of a multicast message requesting participation or secession, wherein a multicast control unit performs a setup in a multicast data transmitting unit according to the multicast transmission table, and a multicast data transmitting unit transmits multicast data from the moving picture distribution network to the domestic termination device by a multicast manner according to a transmitting source address, a multicast group, and interface information.

### Tenth Exemplary Embodiment

According to the tenth exemplary of the present invention, further to the construction described in the eighth exemplary embodiment, if the whole image reproduction device participates in a same multicast group address, the subscriber line termination device establishes a multicast transmission table having different multicast addresses in an upper level network according to a link speed of each interface and notifies an interface connected to the upper level network of a multicast message requesting participation or secession, wherein a multicast control unit performs a setup in a multicast data transmitting unit according to the multicast transmission table, and a multicast data transmitting unit changes an address from an upper level multicast address to a subscriber multicast address and then transmits multicast data from the moving picture distribution network to the domestic termination device by a multicast manner according to designated interface information.

### Eleventh Exemplary Embodiment

According to the eleventh exemplary embodiment of the present invention, a moving picture distribution program that enables a multicast control unit to perform a process of distributing moving picture data from a moving picture distribution network to an image reproduction device connected to a domestic termination device, wherein the moving picture distribution program enables the multicast control unit to select a server according to a link speed with the domestic termination device and transmit moving picture data of a same content from the moving picture distribution network to the domestic termination device at the link speed by a multicast manner.

### Twelfth Exemplary Embodiment

According to the twelfth exemplary embodiment of the present invention, further to the construction described in the eleventh exemplary embodiment, if an interface control unit connected to the domestic termination device notifies the multicast control unit of a link speed information, the moving picture distribution program enables the multicast control unit to determine an applied image quality of the image reproduction device based on an applied image quality selection table that stores data for determining a line speed and an image reproduction device and a multicast transmission table that stores data for determining a link speed of an interface and a multicast address, and transmit the moving picture data from the moving picture distribution network to the domestic termination device by a multicast manner.

### Thirteenth Exemplary Embodiment

According to the thirteenth exemplary embodiment of the present invention, further to the construction described in the eleventh exemplary embodiment, if the whole image reproduction device participates in a same multicast group address, the moving picture distribution program enables the multicast control unit to establish a multicast transmission table having different transmitting source addresses according to a link speed of each interface, notify an interface connected to an upper level network of a multicast message requesting participation or secession, and perform a setup in a multicast data transmitting unit according to the multicast transmission table, and the moving picture distribution program enables a multicast data transmitting unit to transmit multicast data from the moving picture distribution network to the domestic termination device by a multicast manner according to a transmitting source address, a multicast group, and interface information.

### Fourteenth Exemplary Embodiment

According to the fourteenth exemplary embodiment of the present invention, further to the construction described in the eleventh exemplary embodiment, if the whole image reproduction device participates in a same multicast group address, the moving picture distribution program enables the multicast control unit to establish a multicast transmission table having different multicast addresses in an upper level network according to a link speed of each interface, notify an interface connected to the upper level network of a multicast message requesting participation or secession, and perform a setup in a multicast data transmitting unit according to the multicast transmission table, and the moving picture distribution program enables a multicast data transmitting unit to change an address from an upper level multicast address to a subscriber multicast address and then transmit multicast data from the moving picture distribution network to the domestic termination device by a multicast manner according to designated interface information.

### Fifteenth Exemplary Embodiment

According to the fifteenth exemplary embodiment of the present invention, a recording medium stores the moving picture distribution program of any one of the eleventh exemplary embodiment to the fourteenth exemplary embodiment.

The invention disclosed in the patent document 1 relates to a distribution system that intensively manages content distributed from the center server, and this requires many individual functions to be included in the center server. The invention disclosed in the patent document 1 also requires the edge server to notify the center server of a requesting bandwidth using a predetermined function.

On the contrary, the present invention may control the whole elements, such as bandwidth and the like, in the subscriber line termination device (access edge node) and receive content from the optimal distribution server by a multicast manner using a general purpose protocol. Accordingly, the invention disclosed in the patent document 1 and the present invention are different from each other in their own distribution system structure.

The invention disclosed in the patent document 2 relates to a distribution system wherein the aggregation system located in the center side performs intensive management, and this is implemented through association between the aggregation system and user terminals that have individual functions.

On the contrary, the present invention may control the whole elements, such as bandwidth and the like, in the subscriber line termination device (access edge node) and receive content from the optimal distribution server by a multicast manner using a general purpose protocol. Furthermore, the user terminal of the present invention does not require individual functions. Accordingly, the invention disclosed in the patent document 2 and the present invention are different from each other in their own distribution system structure.

Moreover, the invention disclosed in the patent document 3 is characterized by wireless transmission/receipt, and any system, which assumes a plurality of different subscriber lines including a fixed line, is not disclosed in the patent document 3. Additionally, the invention disclosed in the patent document 3 does not have a structure of putting the bandwidths of the lines together to select the optimal distribution server.

On the contrary, the present invention assumes that the subscriber line termination device (access edge node) control a plurality of different subscriber lines and may receive content optimized for each line bandwidth from the distribution server. Accordingly, the invention disclosed in the patent document 3 and the present invention are not similar to each other in either the line control method or the content transmission method according to bandwidth.

What is claimed is:

1. A moving picture distribution system comprising:
a subscriber line termination device connected to a moving picture distribution network to perform a terminating process of a subscriber line; and
an image reproduction device connected to the subscriber line termination device through a domestic termination device, wherein
the subscriber line termination device selects a server according to a link speed with the domestic termination device and transmits moving picture data of a same content to the domestic termination device at the link speed by a multicast manner.

2. The moving picture distribution system of claim 1, wherein
the subscriber line termination device includes
a first message transmitting/receiving unit connected to the moving picture distribution network to transmit/receive a serial-type message,
a multicast data transmitting unit connected to the first message transmitting/receiving unit to transmit multicast data,
a second message transmitting/receiving unit connected to the multicast data transmitting unit to transmit/receive a parallel-type message,
an interface control unit connected to the second message transmitting/receiving unit to connect to the domestic termination device, and
a multicast control unit that controls the first and second message transmitting/receiving units and the multicast data transmitting unit.

3. The moving picture distribution system of claim 2, wherein
the multicast control unit includes an applied image quality selection table that stores data for determining a line speed and an image reproduction device, and
a multicast transmission table that stores data for determining a link speed of an interface and a multicast address.

4. A subscriber line termination device for distributing moving picture data from a moving picture distribution network to an image reproduction device connected to a domestic termination device, wherein
the subscriber line termination device selects a server according to a link speed with a domestic termination device and transmits moving picture data of a same content to the domestic termination device at the link speed by a multicast manner.

5. The subscriber line termination device of claim 4, wherein
the subscriber line termination device includes
a first message transmitting/receiving unit connected to the moving picture distribution network to transmit/receive a serial-type message,
a multicast data transmitting unit connected to the first message transmitting/receiving unit to transmit multicast data,
a second message transmitting/receiving unit connected to the multicast data transmitting unit to transmit/receive a parallel-type message,
an interface control unit connected to the second message transmitting/receiving unit to connect to the domestic termination device, and
a multicast control unit that controls the first and second message transmitting/receiving units and the multicast data transmitting unit.

6. The subscriber line termination device of claim 5, wherein
the multicast control unit includes an applied image quality selection table that stores data for determining a line speed and an image reproduction device, and
a multicast transmission table that stores data for determining a link speed of an interface and a multicast address.

7. A moving picture distribution method for distributing moving picture data from a moving picture distribution network to an image reproduction device connected to a domestic termination device, wherein
the subscriber line termination device selects a server according to a link speed with the domestic termination device and transmits moving picture data of a same content from the moving picture distribution network to the domestic termination device at the link speed by a multicast manner.

8. A moving picture distribution method of claim 7, wherein
if an interface control unit connected to the domestic termination device notifies the subscriber line termination device of a link speed, the subscriber line termination device determines an applied image quality of the image reproduction device based on an applied image quality selection table that stores data for determining a line speed and an image reproduction device and a multicast transmission table that stores data for determining a link speed of an interface and a multicast address, and transmits the moving picture data from the moving picture distribution network to the domestic termination device by a multicast manner.

9. The moving picture distribution method of claim 8, wherein
if the whole image reproduction device participates in a same multicast group address, the subscriber line termination device establishes a multicast transmission table having different transmitting source addresses according to a link speed of each interface and notifies an interface connected to an upper level network of a multicast message requesting participation or secession, wherein a multicast control unit performs a setup in a multicast data transmitting unit according to the multicast transmission table, and a multicast data transmitting unit transmits multicast data from the moving picture distribution network to the domestic termination device by a multicast manner according to a transmitting source address, a multicast group, and interface information.

10. The moving picture distribution method of claim 8, wherein
if the whole image reproduction device participates in a same multicast group address, the subscriber line termination device establishes a multicast transmission table having different multicast addresses in an upper level network according to a link speed of each interface and notifies an interface connected to the upper level network of a multicast message requesting participation or secession, wherein a multicast control unit performs a setup in a multicast data transmitting unit according to the multicast transmission table, and a multicast data transmitting unit changes an address from an upper level multicast address to a subscriber multicast address and then transmits multicast data from the moving picture distribution network to the domestic termination device by a multicast manner according to designated interface information.

11. A recording medium that stores a moving picture distribution program that enables a multicast control unit to perform a process of distributing moving picture data from a moving picture distribution network to an image reproduction device connected to a domestic termination device, wherein
the moving picture distribution program enables the multicast control unit to select a server according to a link speed with the domestic termination device and transmit moving picture data of a same content from the moving picture distribution network to the domestic termination device at the link speed by a multicast manner.

12. The recording medium that stores the moving picture distribution program of claim 11, wherein
if an interface control unit connected to the domestic termination device notifies the multicast control unit of a link speed information, the moving picture distribution program enables the multicast control unit to determine an applied image quality of the image reproduction device based on an applied image quality selection table that stores data for determining a line speed and an image reproduction device and a multicast transmission table that stores data for determining a link speed of an interface and a multicast address, and transmit the moving picture data from the moving picture distribution network to the domestic termination device by a multicast manner.

13. The recording medium that stores the moving picture distribution program of claim 11, wherein
if the whole image reproduction device participates in a same multicast group address, the moving picture distribution program enables the multicast control unit to establish a multicast transmission table having different transmitting source addresses according to a link speed of each interface, notify an interface connected to an upper level network of a multicast message requesting participation or secession, and perform a setup in a multicast data transmitting unit according to the multicast transmission table, and the moving picture distribution program enables a multicast data transmitting unit to transmit multicast data from the moving picture distribution network to the domestic termination device by a multicast manner according to a transmitting source address, a multicast group, and interface information.

14. The recording medium that stores the moving picture distribution program of claim 11, wherein
if the whole image reproduction device participates in a same multicast group address, the moving picture distribution program enables the multicast control unit to establish a multicast transmission table having different multicast addresses in an upper level network according to a link speed of each interface, notify an interface connected to the upper level network of a multicast message requesting participation or secession, and perform a setup in a multicast data transmitting unit according to the multicast transmission table, and the moving picture distribution program enables a multicast data transmitting unit to change an address from an upper level multicast address to a subscriber multicast address and then transmit multicast data from the moving picture distribution network to the domestic termination device by a multicast manner according to designated interface information.
